(19) United States
(12) Patent Application Publication
(10) Pub. No.: US 2017/0060277 A1
(43) Pub. Date: Mar. 2, 2017

(54) MAGNETIC SWITCH ASSEMBLY AND STYLUS HAVING THE SAME

(71) Applicants: Zachary Joseph Zeliff, Taipei (TW); Reinier Bloem, Taipei (TW); Ting-Kuo Kao, Yilan (TW)

(72) Inventors: Zachary Joseph Zeliff, Taipei (TW); Reinier Bloem, Taipei (TW); Ting-Kuo Kao, Yilan (TW)

(21) Appl. No.: 15/246,573

(22) Filed: Aug. 25, 2016

Related U.S. Application Data
(60) Provisional application No. 62/209,347, filed on Aug. 25, 2015.

(51) Int. Cl. G06F 3/0354; H01H 36/00

(52) U.S. Cl. CPC G06F 3/03545; H01H 36/008

(57) ABSTRACT

Embodiments of a magnetic switch assembly and a stylus having the magnetic switch assembly are disclosed. The magnetic switch assembly includes a charging apparatus and a switching apparatus. The charging apparatus includes a housing, a first spring, a first magnet, a second magnet, an insulator layer, and a ball member. The first magnet, the second magnet, and the insulator layer form a recess region with the ball member situated in the center of the recess region. The switching apparatus includes a button, a second spring, and a metal plate. The button includes a contact part and an insulating part. The metal plate has a contact pad disposed on the metal plate. When the button is situated in the recess region of the charging apparatus, power is supplied from the charging apparatus to a power source electrically connected to the metal plate.

### CROSS REFERENCE TO RELATED APPLICATIONS

This application claims the benefit of priority to U.S. provisional patent application No. 62/209,347, filed Aug. 25, 2015, entitled “MAGNETIC SWITCH ASSEMBLY AND STYLUS HAVING SAME”, which is hereby incorporated by reference in its entirety for all purposes.

### BACKGROUND

Field of the Invention

The disclosure relates to a magnetic switch assembly and a stylus having the same, and more particularly to a stylus capable of being switched and charged through the magnetic switch assembly.

Description of Related Art

Generally speaking, styluses for use with capacitive touchscreens require a minimum level of capacitance between the stylus and the touchscreen for the capacitive sensor in the touchscreen to accurately detect the position of the stylus. Nowadays, most such styluses are passive, having a wide conductive tip that is electrically coupled to the stylus body, such that when the body is gripped by a user, the user is electrically coupled to the tip. This allows the capacitance of the user's body to be sensed by the touchscreen across a large enough area to simulate a fingertip touch. Touchscreens on many of the most popular devices today require such large touches and capacitances in order to function; contacts by smaller capacitances or across smaller contact regions are ignored by the devices' firmware in order to reject capacitive noise, thereby helping to lower complexity and cost.

Precisely locating and “touching” points on a screen is aided by having a stylus with a small, non-deforming tip. Not only does a small tip allow the surrounding screen to be seen by the user, thereby helping the user to position the tip precisely, but also a non-deforming tip means that the firmware will have a consistent contact shape from which to determine the centroid.

Higher resolution touchscreens exist, but generally require a stylus that is specifically designed to interact with the given touchscreen so that the touchscreen can ignore other touches as noise. This eliminates the user's ability to use a fingertip to interact with the touchscreen, drastically reducing convenience and requiring that special hardware (the stylus) be developed and kept with the device.

Touchpad capacitive sensors are designed to require close proximity to avoid accidental touch detection, further limiting their capabilities. For example, custom hardware has been developed by some manufacturers that enable a stylus to be detected at some distance from the screen, thus allowing a touchscreen to display a cursor at an anticipated contact point. But this does not work for standard capacitive touchscreens which are designed to detect the capacitance of a user's fingertip; instead, special hardware for these touchscreens requires the use of a special stylus, thereby entirely preventing users from using their fingertips.

However, styluses usually have clumsy solutions for switching the device on or off and charging their internal batteries. A stylus having an elegant and compact solution for switching and charging is therefore desired

### SUMMARY OF CERTAIN ASPECTS OF THE EMBODIMENTS

In one aspect, embodiments of the invention provide a magnetic switch assembly, including a charging apparatus and a switching apparatus. The charging apparatus includes a housing, a first spring, a first magnet, a second magnet, an insulator layer, and a ball member. The second magnet is disposed above the first magnet. The insulator layer is disposed between the first spring and the first magnet. The ball member is attached to one end of the first spring. The first magnet, the second magnet, and the insulator layer form a recess region with the ball member situated in the center of the recess region. The switching apparatus includes a button, a second spring, and a metal plate. The button includes a contact part and an insulating part. The metal plate has a contact pad disposed on the metal plate. When the button is situated in the recess region of the charging apparatus, power is supplied from the charging apparatus to a power source electrically connected to the metal plate.

According to an embodiment of the invention, one end of the insulator layer of the charging apparatus has a chamfer, and the chamfer restricts movement of the ball member attached to the one end of the first spring.

According to an embodiment of the invention, one end of the chamfer is aligned with a side of the first magnet.

According to an embodiment of the invention, the first spring and the second spring are aligned with a central axis of the switching apparatus.

According to an embodiment of the invention, when the button of the switching apparatus is pressed, the second spring is compressed longitudinally and a protruding portion of the button contacts the contact pad disposed on the metal plate.

According to an embodiment of the invention, when the button of the switching apparatus is pressed for a first duration of time, a turn on function is enabled.

According to an embodiment of the invention, when the button of the switching apparatus is pressed for a second duration of time after the turn on function is enabled, a turn off function is enabled.

According to an embodiment of the invention, when the contact part of the button of the switching apparatus is electrically connected to the ball member of the charging apparatus, a charging function is enabled.

According to an embodiment of the invention, the second spring is attached to the button and the metal plate.

According to an embodiment of the invention, the magnetic switch assembly is configured to operate on a stylus.

In another aspect, embodiments of the invention provide a stylus for a capacitive sensor. The stylus includes a stylus body, an amplifier circuit, a tip, a power source, and a magnetic switch assembly. The power source is electrically coupled to the amplifier circuit. The magnetic switch assembly includes a charging apparatus and a switching apparatus. The charging apparatus includes a housing, a first spring, a first magnet, a second magnet, an insulator layer, and a ball member. The second magnet is disposed above the first magnet. The insulator layer is disposed between the first spring and the first magnet. The ball member is attached to one end of the first spring. The first magnet, the second magnet, and the insulator layer form a recess region with the ball member situated in the center of the recess region. The switching apparatus includes a button, a second spring, and a metal plate. The button includes a contact part and an insulating part. The metal plate has a contact pad disposed on the metal plate. When the button is situated in the recess region of the charging apparatus, power is supplied from the charging apparatus to a power source electrically connected to the metal plate.

According to an embodiment of the invention, the magnetic switching assembly charges the power source of the stylus when the charging function is enabled.

### BRIEF DESCRIPTION OF THE DRAWINGS

FIG. 1 is a perspective view of a stylus and a touchscreen according to an embodiment of the invention.

FIG. 2 depicts a perspective view of a switching apparatus in a magnetic switch assembly being configured to operate on a stylus according to an embodiment of the invention.

FIG. 3 is a cross-sectional view of the switching apparatus of FIG. 2 across a line A-A.

FIG. 4 is a perspective of a charging apparatus in a magnetic switch assembly being configured to operate on a stylus according to an embodiment of the invention.

FIG. 5 is a cross-sectional view of the magnetic switch assembly of FIG. 4 across a line B-B.

### DESCRIPTION OF THE EMBODIMENTS

The following detailed description of embodiments references the accompanying drawings that form a part hereof, in which are shown various illustrative embodiments through which the invention may be practiced. In the drawings, like reference numbers indicate like features or functionally identical steps. The embodiments are described in sufficient detail to enable those skilled in the art to practice the invention, and it is to be understood that other embodiments may be utilized and that logical changes may be made without departing from the spirit and scope of the invention. The detailed description is therefore not to be taken in a limiting sense, and the scope of the invention is defined solely by the appended claims.

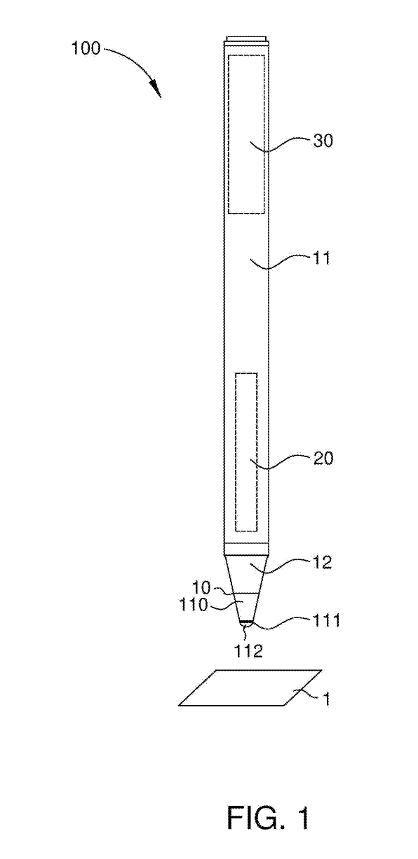

Please refer to FIG. 1, which is a perspective view of a stylus 100 and a touchscreen 1 according to an embodiment of the invention. In the present embodiment, the stylus 100 includes a tip 10, a body 11, a fairing 12, an emitting electrode 110, a sensing electrode 112, and a shield 111. A printed circuit board 20 and a battery 30 depicted as dashed outlines may be housed inside the body 11. The body 11 may be attached into the fairing 12 of the stylus 100. In the present embodiment, the printed circuit board 20 may include all circuitry necessary to implement the various electronic functions of the stylus 100, including a battery charging circuit, an amplifier circuit, and a power source circuit coupled to the amplifier circuit, a communication module for communicating with the touchscreen 1, a power switch, and so forth, although the invention is not limited thereto.

Moreover, an input terminal of the amplifier circuit may be electrically coupled to the sensing electrode 112 of the tip, and an output terminal of the circuit may be electrically coupled to the emitting electrode 110 of the tip. The amplifier circuit may receive a signal through the sensing electrode, amplify and inverts the signal, and output the signal through the emitting electrode 110 to the touchscreen 1. Furthermore, the amplifier circuit may amplify only a portion of the signal that exceeds a threshold voltage. For example, the amplifier circuit may modify amplification of the signal according to information received from the device through the communication module in the printed circuit board 20.

In a passive capacitive stylus, the stylus body may serve to electrically couple a conductive tip to the user's hand. On the other hand, an active stylus does not necessarily need to use the stylus body to couple the conductive tip to the hand, and therefore the active stylus may be made of either conductive or nonconductive materials, or a combination thereof. In the present embodiment, the body 11 of the stylus 100 may serve to hold the tip 10 and to contain active electronic circuitry 20 and the battery 30 for powering the active electronic circuitry 20. In FIG. 1, the tip 10 may be an anodized sensor/emitter tip, for example, although the invention is not limited thereto. The shield 111 may separate the emitting electrode 110 and the sensing electrode 112. The touchscreen 1 may be any type of touchscreen containing a sensor capable of sensing a mutual capacitance between the stylus 100 and the touchscreen 1. For example, the touchscreen 1 may include a capacitive sensor having a plurality of driving lines and a plurality of sensing lines (not shown) for sensing the mutual capacitance the stylus 100 and the touchscreen 1.

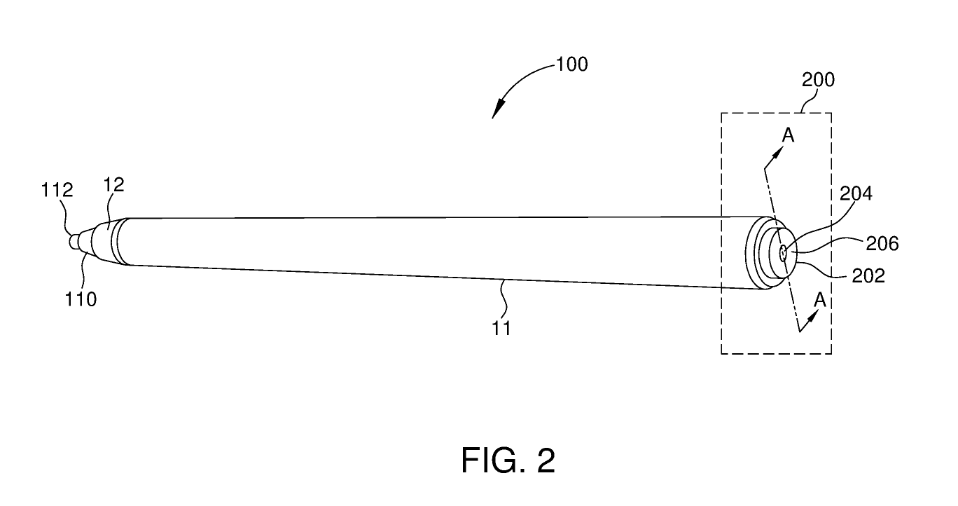

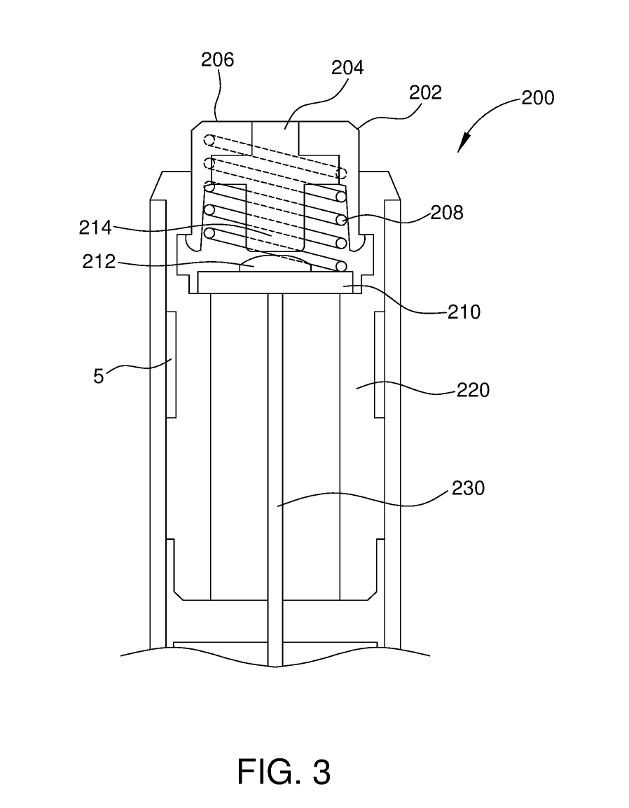

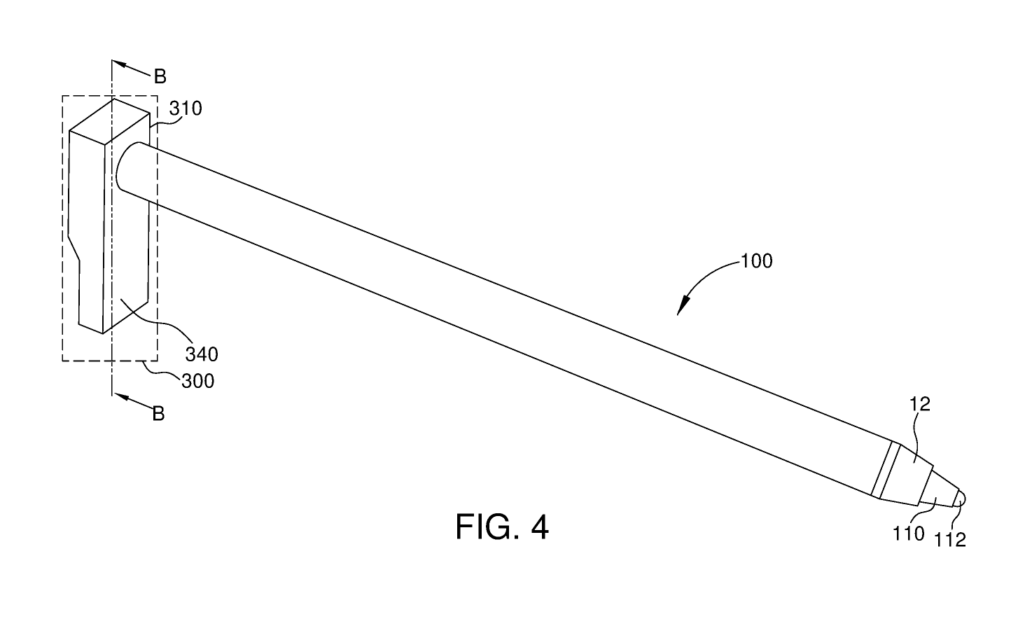

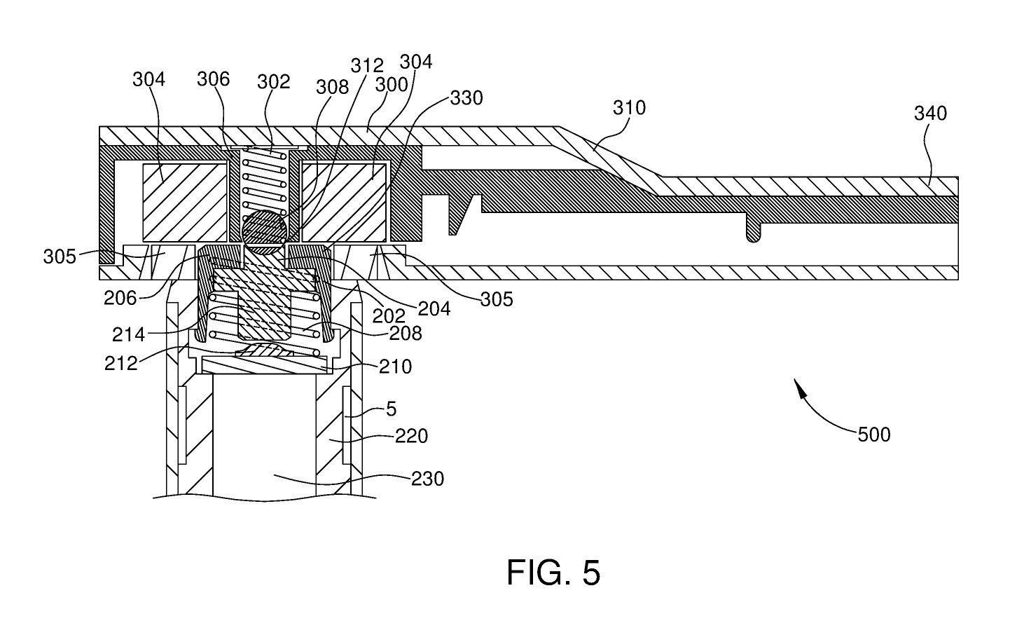

It should be noted that a magnetic switch assembly may be configured to operate on the stylus 100 of FIG. 1, so as to facilitate a convenient and aesthetic solution for charging and turning on or off the stylus 100. Please refer to FIG. 2, FIG. 3, FIG. 4, and FIG. 5 for the following description of a magnetic switch assembly configured to operate on a stylus (e.g. the stylus 100). In the following disclosure, FIG. 2 depicts a perspective view of a switching apparatus in a magnetic switch assembly being configured to operate on a stylus according to an embodiment of the invention; FIG. 3 is a cross-sectional view of the switching apparatus of FIG. 2 across a line A-A; FIG. 4 is a perspective of a charging apparatus in a magnetic switch assembly being configured to operate on a stylus according to an embodiment of the invention; FIG. 5 is a cross-sectional view of the magnetic switch assembly of FIG. 4 across a line B-B. With reference to FIGS. 2 thru 5, a magnetic switch assembly 500 includes a switching apparatus 200 and a charging apparatus 300. As shown in FIG. 3 and FIG. 5, the switching apparatus 200 includes a button 202, a spring 208, and a metal plate 210. The button 202 has a contact part 204 and an insulating part 206. The spring 208 is attached to the button 202 and the metal plate 210. The metal plate 210 has a contact pad 212 disposed on the metal plate 210. In some embodiments, when the button 202 of the switching apparatus 200 is pressed, the spring 208 is compressed longitudinally and a protruding portion 214 of the button 202 contacts the contact pad 212 disposed on the metal plate 210, and thereby turning on or turning off the stylus 100, for example. It should be appreciated that other functions of the stylus 100 may be enabled or disabled by the pressing of the button 202, and the functions may be defined by the duration of the button press. For example, in some embodiments, when the button 202 of the switching apparatus 200 is pressed for a first duration of time (e.g. 0.5 s), a turn on function is enabled. In another embodiment, when the button 202 of the switching apparatus 200 is pressed for a second duration of time (e.g. 0.5 s) after the turn on function is enabled, a turn off function is enabled.

With reference to FIG. 4 and FIG. 5, the charging apparatus 300 includes a spring 302, a first magnet 304, a second magnet 305, an insulator layer 306, a ball member 308, a housing 310, and a connector 340. The second magnet 305 is disposed above the first magnet 304. The insulator layer 306 is disposed between the spring 302 and the first magnet 304. The ball member 308 is attached to one end of the spring 302, which is electrically connected to the connector 340. In the present embodiment, the first magnet 304, the second magnet 305, and the insulator layer form a recess region 330 with the ball member 308 situated in a center of the recess region 330. In one embodiment, one end of the insulator layer 306 of the charging apparatus 300 has a chamfer 312, and the chamfer 312 restricts movement of the ball member 308 attached to the one end of the spring 302. As shown in FIG. 5, one end of the chamfer 312 is aligned with a side of the first magnet 304. In other embodiments, the spring 208 and the spring 302 are aligned with a central axis (not drawn) of the switching apparatus 200. According to other embodiments, the switching apparatus 200 of the magnetic switch assembly 500 may be installed in the stylus 100 by sliding into the switching apparatus 200 into a slot 5 at a distal end of the stylus 100.

When a user needs to charge the stylus 100 with the magnetic switch assembly 500, the button 202 may be situated in the recess region 330 of the charging apparatus 300, such that the stylus 100 is held in place by the first magnet 304 and the second magnet 305, and an electrical connection is made by the contact part 204 of the button 202 and the ball member 308. Power may be supplied from an external source, such as from a computing device (not drawn), and the power may be provided to the battery 30 of the stylus 100 electrically connected to the metal plate 230 through a wire 230.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A magnetic switch assembly, comprising:
a charging apparatus, comprising:
a housing;
a first spring;
a first magnet;
a second magnet, wherein the second magnet is disposed above the first magnet;
an insulator layer disposed between the first spring and the first magnet;
a ball member attached to one end of the first spring,
wherein the first magnet, the second magnet, and the insulator layer form a recess region with the ball member situated in the center of the recess region; and
a switching apparatus, comprising:
a button comprising a contact part and an insulating part;
a second spring; and
a metal plate having a contact pad disposed on the metal plate;
wherein when the button is situated in the recess region of the charging apparatus, power is supplied from the charging apparatus to a power source electrically connected to the metal plate.

2. The magnetic switch assembly according to claim 1, wherein one end of the insulator layer of the charging apparatus has a chamfer, and the chamfer restricts movement of the ball member attached to the one end of the first spring.

3. The magnetic switch assembly according to claim 2, wherein one end of the chamfer is aligned with a side of the first magnet.

4. The magnetic switch assembly according to claim 1, wherein the first spring and the second spring are aligned with a central axis of the switching apparatus.

5. The magnetic switch assembly according to claim 1, wherein when the button of the switching apparatus is pressed, the second spring is compressed longitudinally and a protruding portion of the button contacts the contact pad disposed on the metal plate.

6. The magnetic switch assembly according to claim 1, wherein when the button of the switching apparatus is pressed for a first duration of time, a turn on function is enabled.

7. The magnetic switch assembly according to claim 1, wherein when the button of the switching apparatus is pressed for a second duration of time after the turn on function is enabled, a turn off function is enabled.

8. The magnetic switch assembly according to claim 1, wherein when the contact part of the button of the switching apparatus is electrically connected to the ball member of the charging apparatus, a charging function is enabled.

9. The magnetic switch assembly according to claim 1, wherein the second spring is attached to the button and the metal plate.

10. The magnetic switch assembly according to claim 1, wherein the magnetic switch assembly is configured to operate on a stylus.

11. A stylus for a capacitive sensor, the stylus comprising:
a stylus body;
an amplifier circuit;
a tip;
a power source, the power source electrically coupled to the amplifier circuit;
a magnetic switch assembly, comprising:
a charging apparatus, comprising:
a housing;
a first spring;
a first magnet;
a second magnet, wherein the second magnet is disposed above the first magnet;
an insulator layer disposed between the first spring and the first magnet;
a ball member attached to one end of the first spring,
wherein the first magnet, the second magnet, and the insulator layer form a recess region with the ball member situated in the center of the recess region; and
a switching apparatus, comprising:
a button comprising a contact part and an insulating part;
a second spring; and
a metal plate having a contact pad disposed on the metal plate;
wherein when the button is situated in the recess region of the charging apparatus, power is supplied from the charging apparatus to the power source of the stylus electrically connected to the metal plate.

12. The stylus according to claim 10, wherein one end of the insulator layer of the charging apparatus has a chamfer, and the chamfer restricts movement of the ball member attached to the one end of the first spring.

13. The stylus according to claim 11, wherein one end of the chamfer is aligned with a side of the first magnet.

14. The stylus according to claim 11, wherein the first spring and the second spring are aligned with a central axis of the switching apparatus.

15. The stylus according to claim 11, wherein when the button of the switching apparatus is pressed, the second spring is compressed longitudinally and a protruding portion of the button contacts the contact pad disposed on the metal plate.

16. The stylus according to claim 11, wherein when the button of the switching apparatus is pressed for a first duration of time, a turn on function is enabled.

17. The stylus according to claim 11, wherein when the button of the switching apparatus is pressed for a second duration of time after the turn on function is enabled, a turn off function is enabled.

18. The stylus according to claim 11, wherein when the contact part of the button of the switching apparatus is electrically connected to the ball member of the charging apparatus, a charging function is enabled.

19. The stylus according to claim 18, wherein the magnetic switching assembly charges the power source of the stylus when the charging function is enabled.

20. The stylus according to claim 11, wherein the second spring is attached to the button and the metal plate.
